(19) United States
(12) Patent Application Publication
(10) Pub. No.: US 2006/0062258 A1
(43) Pub. Date: Mar. 23, 2006

(54) Smith-Purcell free electron laser and method of operating same

(75) Inventors: Charles A. Brau, Nashville, TN (US); Charles H. Boulware, Nashville, TN (US); Heather L. Andrews, Nashville, TN (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: Vanderbilt University, Nashville, TN (US)

(21) Appl. No.: 11/172,429

(22) Filed: Jun. 30, 2005

Related U.S. Application Data
(60) Provisional application No. 60/584,960, filed on Jul. 2, 2004.

(51) Int. Cl. H01S 3/00

(52) U.S. Cl. 372/2

(57) ABSTRACT

A free electron laser for generating a Smith-Purcell radiation. In one embodiment, the free electron laser includes a grating having a grating surface, an electron emitter for generating a beam of electrons, and a guiding member positioned therebetween the electron emitter and the grating for directing the beam of electrons along a path extending over the grating surface of the grating with a focal point so that in operation a Smith-Purcell radiation and an evanescent wave are generated by interaction of the beam of electrons with the grating. In operation, the beam current of the beam of electrons is equal to or greater than a threshold current and the group velocity of the evanescent wave is substantially close to zero or negative so that the evanescent wave travels backward to allow electrons in the beam of electrons are bunched by interaction with the evanescent wave to substantially enhance the Smith-Purcell radiation over the range of wavelengths.

### CROSS-REFERENCE TO RELATED PATENT APPLICATION

This application claims the benefit, pursuant to 35 U.S.C. §119(e), of provisional U.S. patent application Ser. No. 60/584,960, filed Jul. 2, 2004, entitled “A Free Electron Laser And Methods For Operating Same,” by Charles A. Brau, Charles H. Boulware and Heather L. Andrews, which is incorporated herein by reference in its entirety.

### STATEMENT OF FEDERALLY-SPONSORED RESEARCH

The present invention was made with Government support under a contract F49620-01-1-0429 awarded by Department of Defense. The United States Government may have certain rights to this invention pursuant to these grants.

Some references, which may include patents, patent applications and various publications, are cited and discussed in the description of this invention. The citation and/or discussion of such references is provided merely to clarify the description of the present invention and is not an admission that any such reference is “prior art” to the invention described herein. All references cited and discussed in this specification are incorporated herein by reference in their entireties and to the same extent as if each reference was individually incorporated by reference. In terms of notation, hereinafter, “[n]” represents the nth reference cited in the reference list. For example, [20] represents the 20th reference cited in the reference list, namely, C. A. Brau, Modern Problems in Classical Electrodynamics (Oxford University Press, New York, 2004), pp. 291-292.

### FIELD OF THE INVENTION

The present invention generally relates to a laser, and in particular to a Smith-Purcell free electron laser operating on a backward wave oscillator mode.

### BACKGROUND OF THE INVENTION

There is currently substantial interest in the development of terahertz (hereinafter “THz”) sources for applications to biophysics, medical imaging, nanostructures, and materials science [1]. Available THz sources, so far, have fallen into three categories: optically pumped gas lasers, solid state devices, and electron-beam driven devices. Optically pumped gas lasers are commercially available and may provide hundreds of lines between 40 and 1000 μm, at powers ranging from 10 μW to 1 W continuous wave (hereinafter “cw”), and up to megawatts pulsed, but they are inherently not tunable. Solid state THz sources include p-type germanium (hereinafter “Ge”) lasers, quantum-cascade lasers, and excitation of numerous materials with sub-picosecond optical laser pulses. Normally, the p-type Ge lasers may be continuously tunable from 1 to 4 THz, but require a large external magnetic field (I Tesla), must be operated at 20 K, and have a limited repetition rate (1 kHz) because of crystal heating [2]. Recently, a semiconductor heterostructure laser has produced up to 2 mW at 4.4 THz, at temperatures up to 50 K [3]. While not tunable, such lasers may be fabricated to produce the frequency desired. Sub-picosecond electromagnetic pulses may be used as broadband sources of the THz radiation. Small pulses may be created by optical rectification of sub-picosecond infrared laser pulses [4] or by optically switching the photoconductor in a small diode antenna [5].

These broadband pulses are good for pump-probe or time-resolved experiments [6], but are less well suited to spectroscopy.

Electron-beam driven sources include backward wave oscillators (hereinafter “BWO”), synchrotrons, and free-electron lasers (hereinafter “FEL”). The shortest wavelength produced to date by a BWO was 0.25 mm, in 1979[7]. Current commercially available BWOs produce milliwatts from 30-1000 GHz. Modern synchrotrons with short electron bunches, such as BESSY II in Berlin [8], and recirculating linacs like the FEL at Jefferson Laboratory [9], produce many watts of broadband radiation out to about 1 THz. Conventional FELs have also been operated in the THz region. The millimeter-wave and far-infrared FELs at University of California Santa Barbara together operate between 2.5 mm and 338 μm and produce 1-15 kW of power in microsecond pulses [10]. Coherently enhanced THz spontaneous emission from relativistic electrons in undulators has been recently observed at ENEA-Frascati with kW power levels in microsecond pulses [11]. However, all these sources (synchrotrons, undulators, and FELs) require large facilities.

An interesting opportunity for a convenient, tunable, narrow-band source is presented by the recent development of a tabletop Smith-Purcell FEL at Dartmouth [12]. This device has demonstrated superradiant emission in the spectral region from 300-900 μm, but barely exceeded threshold. To improve on this performance, it may need to develop electron beams with improved brightness [13] and a better understanding of how these devices operate.

Therefore, a heretofore unaddressed need exists in the art to address the aforementioned deficiencies and inadequacies.

### SUMMARY OF THE INVENTION

In one aspect, the present invention relates to a FEL for generating a Smith-Purcell radiation. In one embodiment, the FEL includes a grating having a first end, an opposite, second end, and a grating surface defined therebetween the first end and the second end. In one embodiment, the grating has a plurality of grooves with a period.

The FEL further includes an electron emitter for generating a beam of electrons. The beam of electrons is characterized with a beam current and an electron velocity. In one embodiment, the electron emitter includes a plurality of microtips which are arranged in an array. In another embodiment, the electron emitter includes a cone-emitter. The electron emitter is capable of controlling the beam current and the electron velocity of the beam of electrons.

The FEL also includes a guiding member which is positioned therebetween the electron emitter and the grating for directing the beam of electrons along a path extending over the grating surface of the grating with a focal point so that in operation a Smith-Purcell radiation and an evanescent wave are generated by interaction of the beam of electrons with the grating. The Smith-Purcell radiation is emitted along a direction having an angle, θ, relative to the path of the beam of electrons. In one embodiment, the Smith-Purcell radiation includes a coherent radiation. The Smith-Purcell radiation is characterized with a range of wavelengths. The evanescent wave is characterized with a phase velocity and a group velocity. In one embodiment, the phase velocity of the evanescent wave is synchronous with the electron velocity of the beam of electrons. The group velocity of the evanescent wave is associated with the beam current of the beam of electrons. In one embodiment, the evanescent wave has a wavelength longer than the longest wavelength of the Smith-Purcell radiation. The focal point is located between the first end and the second end of the greating and in the path over the grating surface of the grating. In one embodiment, the guiding member has a plurality of directing and focusing electrodes.

In operation, the beam current of the beam of electrons is equal to or greater than a threshold current and the group velocity of the evanescent wave is substantially close to zero or negative so that the evanescent wave travels backward, and electrons in the beam of electrons are bunched by interaction with the evanescent wave to substantially enhance the Smith-Purcell radiation over the range of wavelengths. Furthermore, the bunched electrons in the beam of electrons are spatially periodically distributed such that the Smith-Purcell radiation is substantially enhanced at harmonics of the evanescent wave. In one embodiment, the free electron laser operates on a mode at which the group velocity of the evanescent wave is substantially close to zero such that no optical cavity is required. In another embodiment, the free electron laser operates on a backward wave oscillator mode at which the group velocity of the evanescent wave is negative, where the evanescent wave is output from one of the first end and the second end of the grating.

In another aspect, the present invention relates to a laser for generating a Smith-Purcell radiation. In one embodiment, the laser includes a grating member having a modulated surface, an emitter for generating a beam of charged particles, and means for directing the beam of charged particles along a path extending over the modulated surface of the grating member so that a Smith-Purcell radiation and an evanescent wave are generated by interaction of the beam of charged particles with the grating member, where the Smith-Purcell radiation is characterized with a range of wavelengths, and the evanescent wave is characterized with a phase velocity and a group velocity. In one embodiment, the laser further includes means for focusing the beam of charged particles over the modulated surface of the grating member. The grating member in one embodiment has a plurality of grooves with a period. In one embodiment, the emitter has an electron emitter array, and the beam of charged particles includes a beam of electrons. The beam of charged particles is characterized with a beam current and a particle velocity, where the beam current has a threshold current. In one embodiment, the phase velocity of the evanescent wave is controllable to be synchronous with the particle velocity of the beam of charged particles, and the group velocity of the evanescent wave is associated with the beam current of the beam of charged particles.

The grating member and the emitter are adapted such that in operation the group velocity of the evanescent wave is substantially close to zero or negative. The charged particles in the beam of charged particles are bunched by interaction with the evanescent wave to substantially enhance the Smith-Purcell radiation over the range of wavelengths. In one embodiment, the bunched charged particles in the beam of charged particles are spatially periodically distributed so that the Smith-Purcell radiation is substantially enhanced at harmonics of the evanescent wave.

In yet another aspect, the present invention relates to a method for generating a Smith-Purcell radiation. In one embodiment, the method includes the step of passing a beam of electrons along a path extending over a grating member to produce a Smith-Purcell radiation and an evanescent wave by interaction of the beam of the electrons with the grating member. The grating member, in one embodiment, has a modulated surface. In one embodiment, the beam of electrons is characterized with a beam current and an electron velocity, the Smith-Purcell radiation is characterized with a range of wavelengths, and the evanescent wave is characterized with a phase velocity and a group velocity.

The method also includes the step of controlling the interaction of the beam of the electrons with the grating member such that the group velocity of the evanescent wave is substantially close to zero or negative to cause the evanescent wave backward-traveling over the grating member and allow the beam of electrons to be bunched by interaction with the evanescent wave to enhance the Smith-Purcell radiation over the range of wavelengths. In one embodiment, the Smith-Purcell radiation is substantially enhanced at harmonics of the evanescent wave. Additionally, the method includes the step of focusing the beam of electrons over the modulated surface of the grating member.

In a further aspect, the present invention relates to a laser for generating a Smith-Purcell radiation. In one embodiment, the laser has means for generating a beam of electrons passing along a path extending over a grating member to produce a Smith-Purcell radiation and an evanescent wave by interaction of the beam of the electrons with the grating member, where the Smith-Purcell radiation is characterized with a range of wavelengths, and the evanescent wave is characterized with a phase velocity and a group velocity, and means for controlling the interaction of the beam of the electrons with the grating member such that the group velocity of the evanescent wave is substantially close to zero or negative to cause the evanescent wave backward-traveling over the grating member and allow the beam of electrons to be bunched by interaction with the evanescent wave to enhance the Smith-Purcell radiation over the range of wavelengths.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

FIG. 1A shows schematically a Smith-Purcell free electron laser according to one embodiment of the present invention.

FIG. 1B shows schematically the Smith-Purcell radiation generated by the Smith-Purcell free electron laser shown in FIG. 1A.

FIG. 2 illustrates a frequency and phase velocity of the evanescent wave in relation to wave number according to one embodiment of the present invention, respectively.

FIG. 3 illustrates a free-space wavelength of the evanescent wave, and a range of wavelengths of the Smith-Purcell radiation in relation to electron energy according to one embodiment of the present invention, respectively.

FIG. 4 illustrates an amplitude growth rate of the Smith-Purcell free electron laser in relation to electron energy at least according to one embodiment of the present invention.

FIG. 5 illustrates a total power gain of the Smith-Purcell free electron laser in relation to electron energy at least according to one embodiment of the present invention.

FIG. 6 illustrates an amplitude growth rate of the Smith-Purcell free electron laser in relation to electron energy at least according to one embodiment of the present invention.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like parts throughout the views. As used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which has no influence on the scope of the invention. Additionally, some terms used in this specification are more specifically defined below.

### Definitions

The terms used in this specification generally have their ordinary meanings in the art, within the context of the invention, and in the specific context where each term is used.

Certain terms that are used to describe the invention are discussed below, or elsewhere in the specification, to provide additional guidance to the practitioner in describing various embodiments of the invention and how to practice the invention. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and in no way limits the scope and meaning of the invention or of any exemplified term. Likewise, the invention is not limited to various embodiments given in this specification.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the term “evanescent wave” refers to an electromagnetic wave that decays exponentially with the distance from the interface at which it is formed.

As used herein, the term “phase velocity” refers to a velocity with which the phase of any one frequency component of an electromagnetic wave propagates through space.

As used herein, the term “group velocity” refers to a velocity with which the overall shape of the amplitude of an electromagnetic wave, also known as the envelope of an electromagnetic wave, propagates through space.

### Overview of the Invention

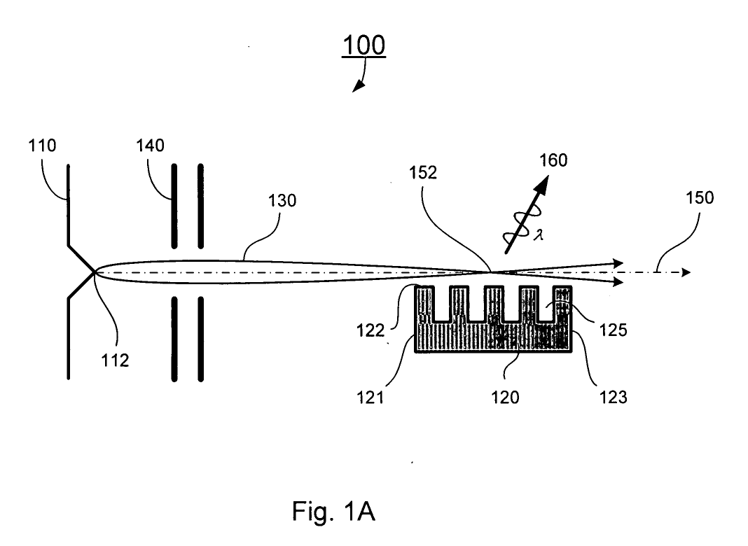

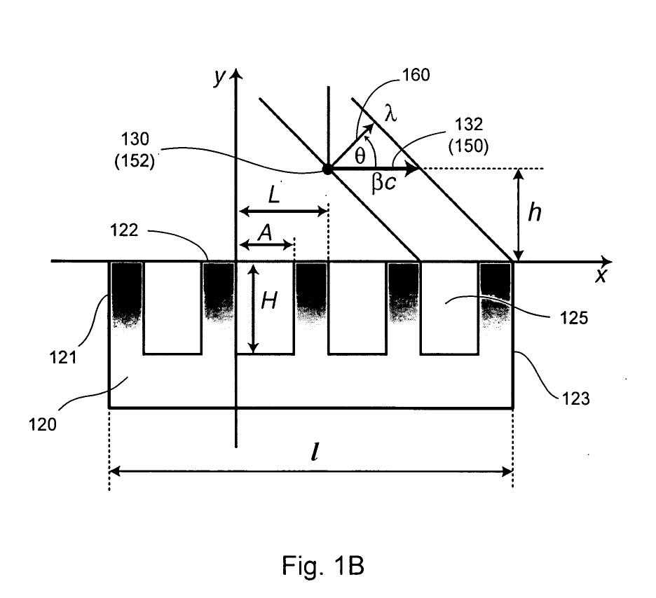

In one aspect, the present invention relates to a FEL for generating a Smith-Purcell radiation. Referring now to FIGS. 1A and 1B, the FEL 100 includes a grating 120. In one embodiment, the grating 120 has a first end 121, an opposite, second end 123, and a grating surface 122 defined therebetween the first end 121 and the second end 123. In one embodiment, the grating 120 has a plurality of rectangular grooves 125 and is characterized with a groove depth, H, a groove width, A, a grating period, L, a grating length, l, defined by the first end 121 and the second end 123, as shown in FIG. 1B. Other gratings having various types of groove profiles, such as a triangle groove profile, or a sinusoidal groove profile, and slow-wave structures having a spatially periodically modulated surface, such as photonic crystals, or dielectric waveguides, can also be utilized to practice the present invention.

As shown in FIG. 1A, the FEL 100 further includes an electron emitter 110 for generating a beam of electrons 130. The beam of electrons 130 is characterized with a beam current and an electron velocity 132, βc, with c the speed of light. In one embodiment, the electron emitter 110 includes a plurality of diamond microtips 112. These microtips 112 are arranged in an array, spacing about 10 μm from each other. The array of the microtips 112 can be formed in any suitable patterns, such as a linear pattern or a rectangle pattern. The electron emitter 110 is capable of controlling the beam current and the electron velocity of the beam of electrons 130. For example, the beam current can be varied by adjusting the electrical potential on the microtips of the electron emitter and/or the bias on electrodes. Other types of electron generators, for instance, a cone-emitter, or a particle generator capable of producing a beam of charged particles, can also be employed to practice the present invention.

Moreover, the FEL includes a guiding member 140. The guiding member 140, in one embodiment, has a plurality of directing and focusing electrodes. In another embodiment (not shown), the guiding member 140 has a plurality of alignment coils, scan coils and solenoidal lens. As shown in FIG. 1A, the guiding member 140 is positioned between the electron emitter 110 and the grating 120 and adapted for directing the beam of electrons 130 along a path 150 extending over the grating surface 122 of the grating 120 with a focal point 152 so that in operation a Smith-Purcell radiation 160 and an evanescent wave are generated by interaction of the beam of electrons 130 with the grating 120. The focal point 152 is located between the first end 121 and the second end 123 of the grating 120 and in the path 150 over the grating surface 122 of the grating 120. The path 150 has a distance, h, from the grating surface 122 of the grating 120, as shown in FIG. 1B. In one embodiment, the beam of electrons 130 is focused into a spot at or around the focal point 152. In another embodiment, the beam of electrons 130 is focused into a slab (or sheet) at or around the focal point 152.

The Smith-Purcell radiation 160 is corresponding to the virtual photons of the electromagnet field of the beam of electrons scattered by the grating 120 and is characterized with a range of wavelengths. As shown in FIG. 1B, the Smith-Purcell radiation 160 with a wavelength λ is emitted along a direction having an angle, θ, relative to the path 150 of the beam of electrons 130. Specifically, the wavelength λ of the Smith-Purcell radiation 160 is in the form of

$$\frac{λ}{L} = \frac{1}{β} - cos θ , \qquad ( 1 )$$

where βc is the electron velocity 132, L the grating period, and c the speed of light. The angular and spectral intensity of the Smith-Purcell radiation were reported by van den Berg and Tan [14-16]. It is obtainable from equation (1) that the wavelength λ of the Smith-Purcell radiation 160 is within the range of wavelengths from λₘᵢₙ=L(1−β)/β to λₘₐₓ=L(1+β)/β, where λₘᵢₙ and λₘₐₓ are corresponding to a Smith-Purcell wavelength for radiation in a direction (θ=0°) that is substantially coincident with the moving direction of the beam of electrons 130, and in a direction (θ=180°) that is substantially opposite to the moving direction of the beam of electrons 130, respectively. In one embodiment, the Smith-Purcell radiation 160 includes a coherent radiation.

The evanescent wave travels along the grating surface 122 of the grating 120 and does not radiate itself. The evanescent wave is characterized with a phase velocity and a group velocity. The group velocity of the evanescent wave is associated with the beam current of the beam of electrons. In one embodiment, the phase velocity of the evanescent wave is synchronous with the electron velocity of the beam of electrons 130.

In operation, the beam current of the beam of electrons 130 is set to be equal to or greater than a threshold current and the group velocity of the evanescent wave is set to be substantially close to zero or negative so that the evanescent wave travels backward. When the beam current in the beam of electrons 130 is sufficiently high, the electrons interact with the evanescent wave generated over the grating 120. This causes nonlinear bunching of the electrons in the beam of electrons 130, which substantially enhances the Smith-Purcell radiation over the range of wavelengths from λₘᵢₙ to λₘₐₓ. Furthermore, due to the periodical features of the evanescent wave, as described in details infra, the interaction of the beam of electrons 130 with the evanescent wave results in the bunched electrons in the beam of electrons 130 to be spatially periodically distributed such that the Smith-Purcell radiation 160 is substantially enhanced at harmonics of the evanescent wave. In one embodiment, the FEL 100 operates on a mode at which the group velocity of the evanescent wave is substantially close to zero such that no optical cavity is required. In another embodiment, the FEL 100 operates on a backward wave oscillator mode at which the group velocity of the evanescent wave is negative. In this embodiment, the evanescent wave is output from one of the first end 121 and the second end 123 of the grating 120. A quartz window close to the grating surface 122 of the grating 120 can be utilized to provide a large collection solid angle to output the Smith-Purcell radiation 160. The evanescent wave has a wavelength longer than the longest wavelength of the Smith-Purcell radiation 160, i.e., λₘₐₓ.

The present invention in another aspect relates to a method for generating a Smith-Purcell radiation. The method in one embodiment includes the steps of passing a beam of electrons along a path extending over a grating member to produce a Smith-Purcell radiation and an evanescent wave by interaction of the beam of the electrons with the grating member, and controlling the interaction of the beam of the electrons with the grating member such that the group velocity of the evanescent wave is substantially close to zero or negative to cause the evanescent wave backward-traveling over the grating member and allow the beam of electrons to be bunched by interaction with the evanescent wave to enhance the Smith-Purcell radiation over the range of wavelengths.

These and other aspects of the present invention are further described below.

### Discoveries, Implementations and Examples of the Invention

Without intend to limit the scope of the invention, further exemplary procedures and preliminary results of the same according to the embodiments of the present invention are given below.

The Smith-Purcell FEL according to one embodiment of the present invention may be explained in scientific terms or theories as follows. A beam of electrons as a uniform plasma are moving in the positive x direction over a grating surface of a grating, and the beam of electrons interacts with an evanescent wave that travels along the grating surface of the grating in synchronism with the beam of electrons. As shown in FIG. 1B, assuming that the region (y>0) above the grating 120 is filled with an uniform plasma, such as a beam of electrons 130, traveling in the x direction 150 with a velocity βc, in the rest frame of the plasma, the magnetic susceptibility vanishes and the dielectric susceptibility is [19]

$${χ}_{e}^{′} = - \frac{{ω}_{p}^{′}}{{ω}^{′2}} , \qquad ( 2 )$$

where ω′ is the optical frequency and

$${{ω}^{′}}_{p}^{2} = \frac{{n}_{e}^{′} {q}^{2}}{{ɛ}_{0} m} \qquad ( 3 )$$

is the plasma frequency in the plasma rest frame, in which n′ₑ is the electron density, q the electron charge, m the electron mass, and ε₀ the permittivity of free space (SI units are used throughout). For a wave of the form exp[i(\vec{k}′·\vec{r}′−ω′t′)], where \vec{k}′ is the wave vector, \vec{r}′ the position, and t′ the time in the plasma rest frame, it is obtained from the wave equation that

$$\frac{{ω}^{′2}}{{c}^{2}} - \vec{{k}^{′}} \cdot \vec{{k}^{′}} = {k}^{′α} {k}_{α}^{′} = - {χ}_{e}^{′} \frac{{ω}^{′2}}{{c}^{2}} , \qquad ( 4 )$$

where k′^{α}=(ω′/c,\vec{k}′), and k′^{α}k′_{α} is a Lorentz invariant. In the laboratory frame

$${k}^{α} {k}_{α} = \frac{{ω}^{2}}{{c}^{2}} - \vec{k} \cdot \vec{k} = - {χ}_{e}^{′} \frac{{ω}^{′2}}{{c}^{2}} = \frac{{ω}_{p}^{2}}{γ {c}^{2}} , \qquad ( 5 )$$

where ω is the frequency and \vec{k} the wave vector in the laboratory frame, γ=1/\sqrt{1−β²}, and the plasma frequency in the laboratory frame is ωₚ²=γω′ₚ², due to Lorentz contraction.

The polarization in the laboratory frame is given by the relativistically correct constitutive relation [20]

$$\vec{P} - \frac{\vec{v} \times \vec{M}}{{c}^{2}} = {ɛ}_{0} {χ}_{e}^{′} ( \vec{E} + \vec{v} \times \vec{B} ) , \qquad ( 6 )$$

where \vec{M} is the magnetization, \vec{v}=βc\vec{\hat{x}} the velocity, \vec{E} the electric field, and \vec{B} the magnetic field. The displacement in the x component is then expressed as
Dₓ=ε₀Eₓ+Pₓ=ε₀(1+χ′ₑ)Eₓ. (7)

The frequency in the plasma rest frame is the form of

$$\frac{{ω}^{′}}{c} = γ ( \frac{ω}{c} - β {k}_{ϰ} ) \qquad ( 8 )$$

so the dielectric susceptibility takes the form of

$${χ}_{e}^{′} = \frac{- {ω}_{p}^{2}}{{γ}^{3} ( ω - β {ck}_{ϰ} )} , \qquad ( 9 )$$

which diverges at the synchronous point,
ω=βckₓ. (10)

In the following one is focused on TM waves, for which the magnetic field in the direction vanishes. To describe the wave in the evanescent region, the \vec{E} and \vec{H} fields can be expanded in the form by the Floquet's theorem

$$\begin{matrix}{E}_{x} = {\sum }_{p = - ∞}^{∞} {E}_{p} {ⅇ}^{- {α}_{p} y} {ⅇ}^{ⅈ pKx} {ⅇ}^{ⅈ ( kx - ω t )} , & ( 11 ) \\ {H}_{y} = {\sum }_{p = - ∞}^{∞} {H}_{p} {ⅇ}^{- {α}_{p} y} {ⅇ}^{ⅈ pKx} {ⅇ}^{ⅈ ( kx - ω t )} , & ( 12 )\end{matrix}$$

where Eₚ and Hₚ are constants, and

$$K = \frac{2 π}{L} \qquad ( 13 )$$

is the grating wave number. For convenience, hereinafter, k is used to denote the x component of the wave vector, rather than its magnitude. From the wave equation it is found that

$${α}_{p}^{2} = ( k + {pK}^{2} ) - \frac{{ω}^{2}}{{c}^{2}} + \frac{{{ω}^{′}}_{p}^{2}}{{c}^{2}} . \qquad ( 14 )$$

Computations show that the wave is evanescent (nonradiative), since αₚ^{2>0} for all p. To satisfy the boundary condition that the wave vanish in the limit y→∞, the negative root αₚ²<0 is chosen. From the Maxwell-Ampere law it is obtained that
αₚHₚ=iε₀ω(1+χ′ₚ)Eₚ, (15)
where the dielectric susceptibility at the frequency of the p^{th} component is

$${χ}_{e}^{′} = \frac{- {ω}_{p}^{2}}{{{γ}^{3} [ ω - βc ( k + pK ) ]}^{2}} . \qquad ( 16 )$$

When the wave is nearly synchronous, the susceptibility is nearly divergent only for p=0, so equation (15) is written in the form

$${H}_{p} = {ⅈɛ}_{0} \frac{ω}{{α}_{p}} ( 1 + {δ}_{p0} {χ}_{0}^{′} ) {E}_{p} . \qquad ( 17 )$$

In the grooves of the grating the fields are expanded in the Fourier series

$$\begin{matrix}{E}_{ϰ} = {\sum }_{n = 0}^{∞} {\overline{E}}_{n} cos ( \frac{n π ϰ}{A} ) \frac{sin h [ {κ}_{n} ( y + H ) ]}{cos h [ {k}_{n} H ]} {ⅇ}^{- ⅈ ω t} , & ( 18 ) \\ {H}_{y} = {\sum }_{n = 0}^{∞} {\overline{H}}_{n} cos ( \frac{n π ϰ}{A} ) \frac{cos h [ {κ}_{n} ( y + H ) ]}{sin h [ {k}_{n} H ]} {ⅇ}^{- ⅈ ω t} , & ( 19 )\end{matrix}$$

where \overline{E}ₙ and \overline{H}ₙ are constants, A is the width of the groove, and H the depth. These expressions (18) and (19) satisfy the boundary conditions that Eₓ vanish at the bottom of the groove (y=−H), and E_{y} vanish at the sides of the groove (x=0, A). κₙ is governed by

$${κ}_{n}^{2} = {( \frac{n π}{A} )}^{2} - \frac{{ω}^{2}}{{c}^{2}} , \qquad ( 20 )$$

and according to the Maxwell-Ampere law \overline{E}ₙ and \overline{H}ₙ satisfy the relationship of

$${\overline{H}}_{n} = ⅈ ɛ \frac{ω}{{k}_{n}} tan h ( {κ}_{n} H ) {\overline{E}}_{n} . \qquad ( 21 )$$

Across the interface between the grating and the beam of electrons, the tangential component of the electric field is continuous. Since the tangential field vanishes on the surface of the conductor, it is got that (suppressing the e^{-iωt} dependence)

$${\sum }_{p = - ∞}^{∞} {E}_{p} {e}^{ⅈ ( k + pK ) x} = \{ \begin{matrix}{\sum }_{n = 0}^{∞} {\overline{E}}_{n} cos ( \frac{n π ϰ}{A} ) tan h ( {κ}_{n} H ) & for 0 < x < A & & \\ 0 & for A < x < L & . & \end{matrix} \qquad ( 22 )$$

Multiplying the expression (22) by e^{-i(k+pK)x} and then integrating it over 0<x<L gives rise to

$$\begin{matrix}{E}_{p} = {\sum }_{n = 0}^{∞} {\overline{E}}_{n} tan h ( {κ}_{n} H ) \frac{{K}_{qn}}{L} , & ( 23 ) \\ {K}_{pn} = ⅈA \frac{( k + qK ) A}{{( k + qK )}^{2} {A}^{2} - {n}^{2} {π}^{2}} [ {( - 1 )}^{n} {e}^{- ⅈ ( k + qK ) A} - 1 ] . & ( 24 )\end{matrix}$$

Likewise, the tangential component of the magnetic field must be continuous across the interface, so

$${\sum }_{p = - ∞}^{∞} {H}_{p} {e}^{ⅈ ( k + pK ) x} = {\sum }_{n = 0}^{∞} {\overline{H}}_{n} cos ( \frac{n π ϰ}{A} ) coth ( {κ}_{n} H ) . \qquad ( 25 )$$

Multiplying the expression (25) by cos(mπx/A) and then integrate it over 0<x<L leads to

$${\overline{H}}_{m} \frac{1 + {δ}_{m0}}{m π} coth ( {κ}_{m} H ) = {\sum }_{p = - ∞}^{∞} {H}_{p} \frac{{K}_{pm}}{A} . \qquad ( 26 )$$

Substituting Gauss's laws (17) and (21) into (26), substituting (23) for Eₚ, and reversing the order of summation leads to

$${\overline{E}}_{m} = {\sum }_{n = 0}^{∞} {C}_{mn} {\overline{E}}_{n} , \qquad ( 27 )$$

where

$${C}_{mm} = ⅈ \frac{2 {κ}_{m} A}{m π} \frac{tan h ( {κ}_{n} H )}{( 1 + {δ}_{m0} )} {\sum }_{p = - ∞}^{∞} \frac{( k + qK )}{{α}_{p}} ( 1 + {δ}_{p0} {ϰ}_{0} ) {K}_{pm} {K}_{pn} . \qquad ( 28 )$$

For a solution to exist, the determinant of the coefficients must vanish,
|Cₘₙ−δₘₙ|=0. (29)
This is the dispersion relation, and its roots give the functional dependence ω(k).

For convenience, writing the expression (29) in the form
Cₘₙ=Rₘₙ+χ₀Sₘₙ, (30)
where after some algebra it is obtained that

$${R}_{mn} = \frac{tan h ( {κ}_{n} H )}{( 1 + {δ}_{m0} )} {\sum }_{p = - ∞}^{∞} \frac{{κ}_{m} A}{{α}_{p} L} \frac{4}{{( k + pK )}^{2} {A}^{2} - {m}^{2} {π}^{2}} \frac{{( k + qK )}^{2} {A}^{2}}{{( k + pK )}^{2} {A}^{2} - {n}^{2} {π}^{2}} \times \{ \begin{matrix}{( - 1 )}^{m} cos [ ( k + pK ) A ] - 1 & for m + n = even \\ {ⅈ ( - 1 )}^{m} sin [ ( k + pK ) A ] & for m + n = odd\end{matrix} \qquad ( 31 )$$

and

$${S}_{mn} = \frac{tan h ( {κ}_{n} H )}{( 1 + {δ}_{m0} )} \frac{{κ}_{m} A}{{α}_{0} L} \frac{4}{{k}^{2} {A}^{2} - {m}^{2} {π}^{2}} \frac{{k}^{2} {A}^{2}}{{k}^{2} {A}^{2} - {n}^{2} {π}^{2}} \times \{ \begin{matrix}{( - 1 )}^{m} cos [ kA ] - 1 & for m + n = even \\ {ⅈ ( - 1 )}^{m} sin [ kA ] & for m + n = odd\end{matrix} . \qquad ( 32 )$$

In the absence of the beam of electrons, the dispersion relation is
|Rₘₙ−δₘₙ|=0. (33)

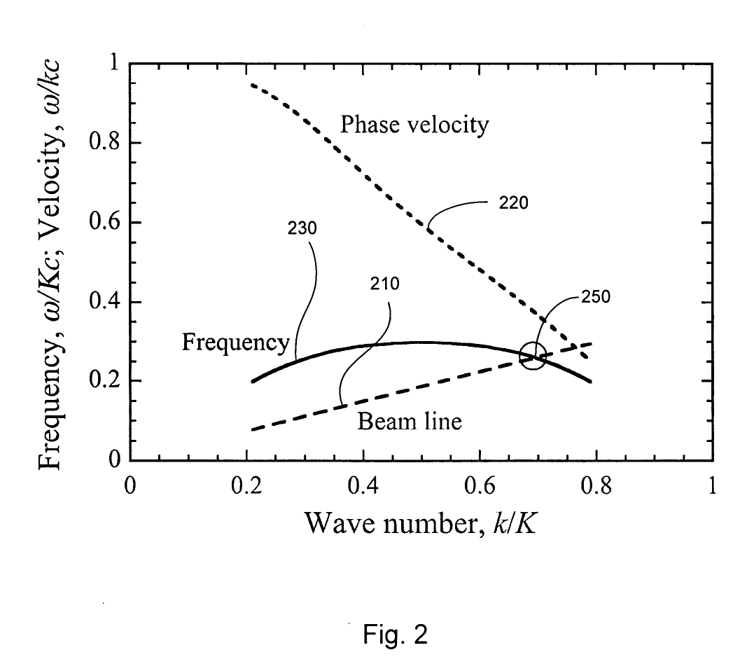

Referring now to FIG. 2, the frequency and phase velocity of the evanescent wave are shown according to one embodiment of the present invention, in which calculating are carried out using MathCad® (Mathsoft Engineering & Education, Inc Cambridge, Mass.). In the exemplary embodiment, the grating and the beam of electrons are chosen such that the parameters, such as grating period (L), groove width (A), groove depth (H), electron energy, electron-beam current and electron-beam diameter, are same as that used in the experiment of Urata et al [12], which are summarized in Table 1. Other values of the parameters can also be used to practice the present invention. As shown in FIG. 2, an operating point of the Smith-Purcell FEL corresponds to the point 250 of which the beam line, βk/K, 210 intersects the frequency curve 230. In the embodiment shown in FIG. 2, the electron energy is adjusted to be about 40 keV, the resultant intersection 250 occurs at a point k/K>0.5, with dω/dk<0. These results indicate that while the evanescent wave travels with a positive phase velocity 220 equal to the electron velocity, the group velocity dω/dk of the evanescent wave is negative, in the manner of a backward-wave oscillator. The waves are evanescent, i.e., vanishing exponentially at distance above the grating.

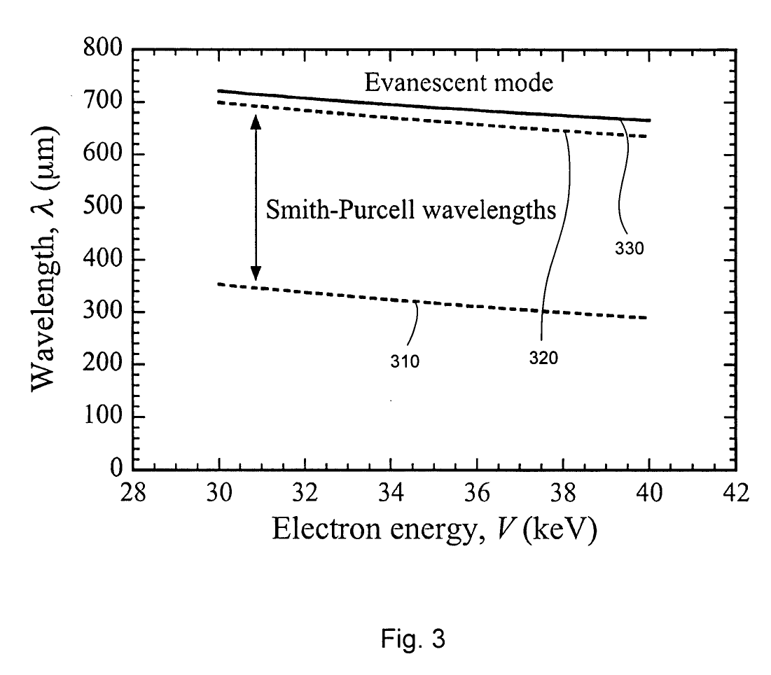

FIG. 3 shows a wavelength 330 of the evanescent wave, and a range of wavelengths of the Smith-Purcell FEL for the grating and the beam of electrons used in FIG. 2. The shortest wavelength 310 of the Smith-Purcell FEL is corresponding to the Smith-Purcell radiation at the direction (θ=0°) substantially coincident with the direction of the beam of electrons, while the longest wavelength 320 of the Smith-Purcell FEL is corresponding to the Smith-Purcell radiation at the direction (θ=180°) substantially opposite to the direction of the beam of electrons. As shown in FIG. 3, the wavelength 330 of the evanescent wave is longer than the longest wavelength 320 of the Smith-Purcell FEL.

TABLE 1
Parameters of Smith-Purcell FEL.

| | | |
|---|---|---|
| Grating period (L) | 173 | μm |
| Groove width (A) | 62 | μm |
| Groove depth (H) | 100 | μm |
| Electron energy | 30-40 | keV |
| Electron-beam current | 1 | mA |
| Electron-beam diameter | 24 | μm |

The dispersion relation is accurately described (within a few percent) by equation (33) even if just a single element, i.e., m=n=0, is used in the matrix of coefficients Cₘₙ, provided that at least three terms are used in the sum for the coefficients, i.e., −1≦p≦1. Thus the field in the grooves is adequately represented by a single term (n=0), at least for k<K, but that the evanescent wave must at least minimally reflect the periodicity of the grating.

To compute the gain of the Smith-Purcell FEL with this simplification, the dispersion relation (33) is then expressed as
R₀₀₋₁+χ₀δ₀₀₌₀. (34)
When the effect of the beam of electrons is substantially small, the solution of equation (34) is expanded for a no-beam case,
R₀₀(ω,k)≈R₀₀(ω₀,k₀)+R′₀₀(ω₀,k₀)(k−k₀) (35)
where
R₀₀(ω₀,k₀)=1. (36)
To lowest order, equation (34) is expressed as
R′₀₀(ω₀,k₀)(k−k₀)+χ₀S₀₀(ω₀,k₀)=0. (37)

But the susceptibility diverges near the synchronous point, so the gain of the Smith-Purcell FEL is very large thereon. For example, for the point
ω₀=βck₀, (38)
the susceptibility is in the form

$${χ}_{0} = - \frac{{ω}_{p}^{2}}{{{γ}^{3} ( {ω}_{0} - βc )}^{2}} = \frac{{ω}_{p}^{2}}{{γ}^{3} {β}^{2} {{c}^{2} ( k - {k}_{0} )}^{2}} . \qquad ( 39 )$$

Substituting the express (39) back into (37) results in

$${( k - {k}_{0} )}^{3} = \frac{{ω}_{p}^{2}}{{γ}^{3} {β}^{2} {c}^{2}} \frac{{S}_{00} ( {ω}_{0} , {k}_{0} )}{ {R}_{00}^{′} ( {ω}_{0} , {k}_{0} )} . \qquad ( 40 )$$

Of the three roots, the root with the largest negative imaginary part has the highest gain, accordingly the amplitude growth rate is

$$μ = Im ( k - {k}_{0} ) = \frac{\sqrt{3}}{2} {\vert \frac{{ω}_{p}^{2}}{{γ}^{3} {β}^{2} {c}^{2}} \frac{{S}_{00} ( {ω}_{0} , {k}_{0} )}{ {R}_{00}^{′} ( {ω}_{0} , {k}_{0} )} \vert}^{1 / 3} . \qquad ( 41 )$$

The growth rate for the power is twice of this value. After the differentiations and cancel common factors from S₀₀ and R′₀₀, the growth rate is then obtained to be

$$μ = \frac{\sqrt{3}}{2} {\vert \frac{{ω}_{p}^{2}}{{γ}^{3} {β}^{2} {c}^{2}} \frac{G ( {ω}_{0} , {k}_{0} )}{ {F}^{′} ( {ω}_{0} , {k}_{0} )} \vert}^{1 / 3} , \qquad ( 42 )$$

where

$$G ( ω , k ) = \frac{cos ( kA ) - 1}{{α}_{0} {Lk}^{2} {A}^{2}} \qquad ( 43 )$$

and

$${F}^{′} ( ω , k ) = {\sum }_{p = - ∞}^{∞} \{ \frac{A sin [ ( k + pK ) A ]}{{α}_{p} {L ( k + pK )}^{2} {A}^{2}} + \frac{cos [ ( k + pK ) A ]}{{α}_{p} {L ( k + pK )}^{2} {A}^{2}} [ \frac{k + qK}{{α}_{p}^{2}} + \frac{2}{k + qK} ] \} . \qquad ( 44 )$$

The power gain per pass is then in the form
g=e^{2μZ}, (45)
where Z is the overall length of the grating.

In one embodiment of the present invention, the beam of electrons is assumed to uniformly fill a region of diameter dₑ, the corresponding plasma frequency in the beam of electrons is

$${ω}_{p}^{2} = \frac{16 {c}^{2}}{β {d}_{e}^{2}} \frac{{I}_{e}}{{I}_{A}} , \qquad ( 46 )$$

where I_{A}=4πε₀mc³/q is the Alfven current, and Iₑ is the beam current in the beam of electrons. By further assuming that the uniform region of the beam of electrons is larger than the scale height s=1/α₀=βγλ/2π of the evanescent wave and the width of the optical mode, the amplitude growth rate of the Smith-Purcell FEL is obtained to be

$$μ = \frac{\sqrt{3}}{β γ} {\vert \frac{4 π}{{d}_{e}^{2} L} \frac{{I}_{e}}{{I}_{A}} \frac{G ( {ω}_{0} , {k}_{0} )}{ {F}^{′} ( {ω}_{0} , {k}_{0} )} \vert}^{1 / 3} . \qquad ( 47 )$$

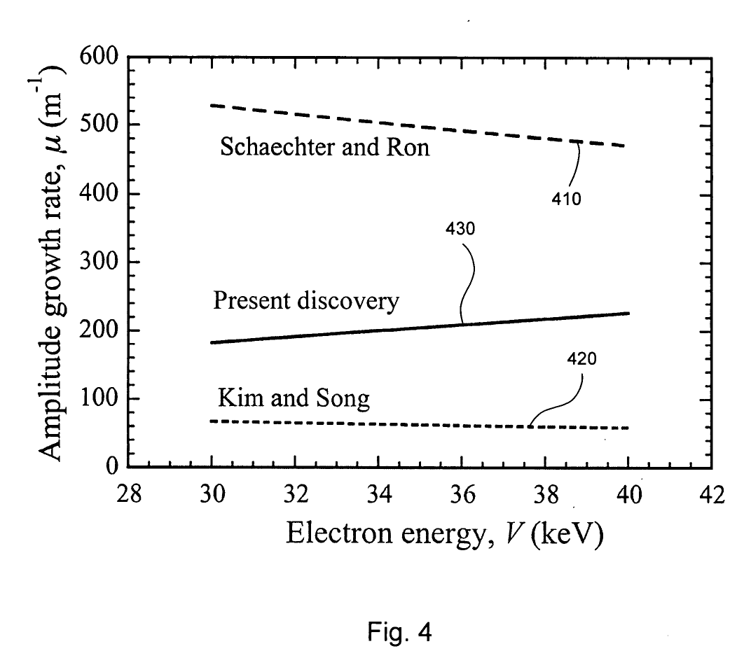

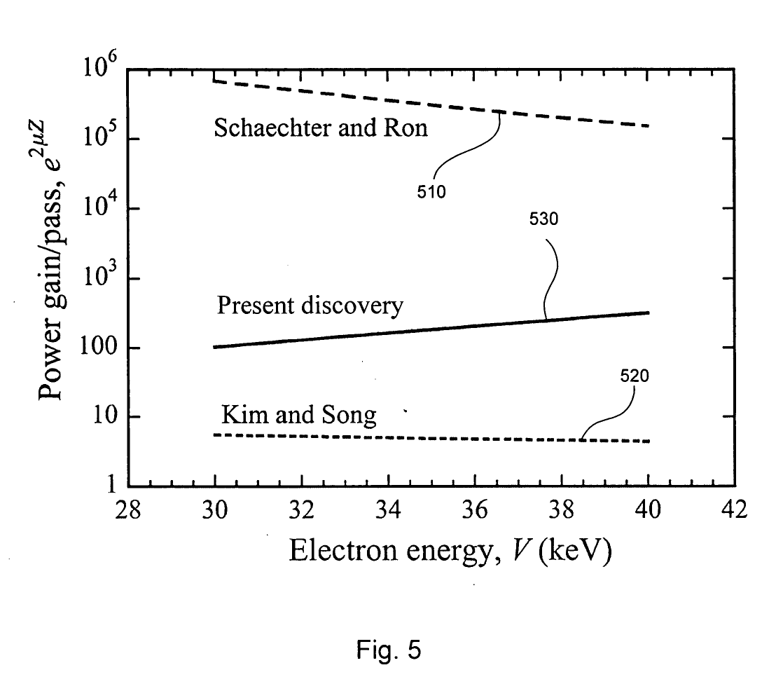

Referring to FIGS. 4 and 5, the amplitude growth rate 430 and the gain 530 of the Smith-Purcell FEL according to one embodiment of the present invention are respectively shown according to the embodiment where the parameters of the grating and the beam of electrons, as listed in Table 1, are chosen to be same as that used in the experiment parameters of Urata et al [12]. Urata et al did not measure the gain directly, but if it is supposed that the traveling wave reflects off the ends of the grating in the manner of an optical resonator with high, for example, 90%, output coupling at each end, then the gain per pass at threshold might be on the order of 100. This agrees with the discoveries of the present invention, as shown in FIG. 5.

For the purposes of comparison and feasibility, the amplitude growth rate 410 and 420 and the gain 510 and 520 predicted by Schaechter and Ron [17], and Kim and Song [18] are also presented in FIGS. 4 and 5, respectively. Schaechter and Ron [17] analyze the interaction of a beam of electrons with a wave traveling along the grating, and include waves that are emitted by the beam and reflected off the grating. The Schaechter and Ron theory treats the system as an amplifier, and calculate is the growth rate of a wave that is incident on the grating from infinity. Accordingly, the amplitude growth rate is

$$μ = \frac{\sqrt{3}}{2} {\vert \frac{4 π}{{d}_{e}} \frac{{ω}^{2}}{{c}^{2}} \frac{{ⅇ}^{- 2 {α}_{0} h}}{{( γ β )}^{5}} \frac{{I}_{e}}{{I}_{A}} \vert}^{1 / 3} , \qquad ( 48 )$$

where h is the distance of the beam of electrons from the surface of the grating. As indicated in equations (47) and (48), the dependence of the amplitude growth rate on the diameter dₑ of the beam of electrons disclosed in the present invention is different from that predicted by Schaechter and Ron [17]. The difference between the dependences results from the fact that for a finite-sized beam traveling as close to the grating as possible, h=dₑ/2 is assumed according to the present invention, however, in the Schaechter and Ron theory, the beam of electrons is assumed to be a sheet of width dₑ positioned above the grating at the height h. Another theory has been reported by Kim and Song [18]. Like Schaechter and Ron, Kim and Song consider a sheet electron beam of width dₑ positioned at a height h above the grating that interacts with a Floquet wave traveling along the surface of the grating. However, Kim and Song assume that at least one of the Fourier components of the Floquet wave is radiative, rather than evanescent as disclosed in the present invention. That is, at least one component of the wave is not exponentially decreasing away from the grating surface. Consequently, Kim and Song obtain the growth rate to be in the form

$$μ = \frac{\sqrt{3}}{{( γ β )}^{2}} \sqrt{\frac{4 π {ke}_{00} {ⅇ}^{- 2 {α}_{0} h}}{{d}_{e}} \frac{{I}_{e}}{{I}_{A}} ,} \qquad ( 49 )$$

where e₀₀ is a grating coupling coefficient whose value is on the order of unity. The predicted gain by Kim and Song depends on the square root of the electron-beam current rather than the cube root, as predicted by the present invention and inferred by Bakhtyari, Walsh, and Brownell [21]. The different dependence of the gain on the electron-beam current may be due to the fact that Kim and Song assume that at least one component of the Floquet wave radiates as it travels along the grating, and this introduces a loss mechanism that is not taken into account in the Schaechter and Ron theory [17] and the Kim and Song theory [18].

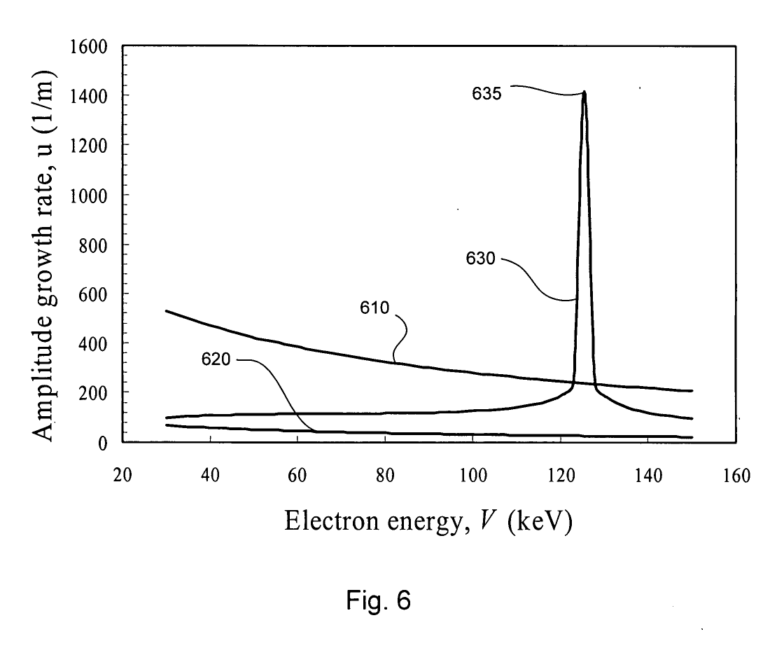

Referring to FIG. 6, the amplitude growth rate 630 of the Smith-Purcell FEL for the parameters listed in Table 1 is shown. It is interesting to note that the amplitude growth rate 630 (or gain) of the Smith-Purcell FEL according to one embodiment of the present invention increases with the electron energy, whereas both the Schaechter and Ron theory and the Kim and Song theory predict that the amplitude growth rate (gain) 610 and 630 decreases with the electron energy. As described supra, the gain increasing with the electron energy is due to the dispersion relation, which is explicitly accounted in the present discoveries, but not in the Schaechter and Ron theory and the Kim and Song theory. In a fundamental view, the net gain for the evanescent wave is a balance between the energy absorbed from the beam of electrons and that lost by energy flow along the grating. But the energy in the evanescent wave travels at the group velocity, dω/dk, which depends on the wave number of the evanescent wave, as indicated in FIG. 2.

As shown in FIG. 6, the peak 635 in the amplitude growth rate 630 occurring at the electron energy about 125 keV corresponds to a zero-group-velocity condition of which the group velocity of the evanescent wave is zero. On the low electron energy side of the peak 635 the group velocity of the evanescent wave is negative, while the group velocity of the evanescent wave is positive on the high electron energy side of the peak 635. When the Smith-Purcell FEL operates on the zero-group-velocity condition the amplitude growth rate (gain) is substantially enhanced according to one embodiment of the present invention. The output power of the coherent Smith-Purcell radiation is also enhanced at the zero-group-velocity condition. When the Smith-Purcell FEL operates far from the zero-group-velocity condition, the gain is much smaller and the energy in the evanescent wave travels toward one of the first end and the second end of the grating. The experiment of Urata et al [12] was conducted at an electron energy range between about 30 keV and 40 keV, which are well below the peak electron energy 125 keV.

The Smith-Purcell FEL can also operate with a very low electron-beam current to generate radiation in the THz spectral region. For example, Table 2 lists parameters achieved according to one embodiment of the present invention. In the exemplary embodiment, the saturated power of the Smith-Purcell radiation is about 90 mW for the beam current in the beam of electrons about 100 μA.

TABLE 2
Parameters of Smith-Purcell FEL.

| | | |
|---|---|---|
| Beam current (10 tips) | 100 | μA |
| Electron energy | 10 | kV |
| Spot distance over the grating (h) | 30 | μm |
| Grating length (l) | 20 | mm |
| Grating period (L) | 150 | μm |
| Groove width (A) | 80 | μm |
| Groove depth (H) | 180 | μm |
| Wavelength | 1 | mm |
| Start parameter | 2.7 | |
| Saturated power | 90 | mW |

The present invention, among other unique things, discloses a mechanism of the Smith-Purcell FEL of the present invention. According to the present invention, a Smith-Purcell FEL can be designed to optimize either the Smith-Purcell radiation or the evanescent wave. If the first end and the second end of the grating are constructed to reflect the evanescent mode, as may be done by tapering the grating period to form Bragg reflectors, then the evanescent mode grows to saturation and the Smith-Purcell radiation is enhanced by strong bunching of electrons in the beam of electrons. This may offer the advantages of angle tuning, in addition to tuning by the electron energy, and even multiple simultaneous wavelengths. However, the radiation at any given frequency would be reduced by the distribution of the Smith-Purcell radiation over the range of wavelengths. Alternatively, one or both the first end and the second end of the grating may be used to output the energy in the evanescent mode, making the Smith-Purcell FEL operate in the manner of a backward-wave oscillator. This may have the advantage of putting all the energy in a single wavelength, but the output energy would appear at a longer wavelength. In this case, as described supra, it is possible to output certain energy in the evanescent wave at one of the first end and the second end of the grating. One or both of the first end and the second end of the grating can be designed to reflect as much or little of the radiation as desired to optimize the operation of the device, and an optical cavity may also be used. When the group velocity of the evanescent wave is substantially close to zero, the energy in the evanescent wave does not travel to the first end and the second end of the grating, thus no reflections and no output of the evanescent wave occur at both the first end and the second end of the grating. The power of the Smith-Purcell FEL is taken out in the coherently enhanced Smith-Purcell radiation. Since this radiation is emitted in a direction upward from the grating, an optical cavity is not required in this embodiment.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

### LIST OF REFERENCES

[1] S. P. Mickan and X.-C. Zhang, Int. J. High-Speed Electron and Sys. 13, 601 (2003).
[2] E. Brundermann, D. R. Chamberin, and E. E. Haller. Inf. Phys. Tech., 40, 141 (1999).
[3] R. Koehler, A. Tredicucci, F. Beltram, H. E. Beere, E. H. Linfield, A. G. Davies, D. A. Ritchie, R. C. lotti, and F. Rossi, Nature 417, 156 (2002).
[4] A. Bonvalet and M. Joffre, “Terahertz femtosecond pulses,” in Femtosecond laser pulses, C. Rulliere, ed. (Springer Verlag, Berlin, 1998).
[5] X.-C. Zhang and D. H. Auston, J. Appl. Phys. 71, 326 (1992).
[6] Ch. Fattinger and D. Grischkowsky, Appl. Phys. Lett., 53, 1480 (1988).
[7] K. J. Button, Infrared and Millimeter Waves (Academic Press, New York, 1979).
[8] M. Abo-Bakr, J. Feikes, K. Holldack, G. Wuestefeld, and H.-W. Huebers, Phys. Lett., 88, 254801 (2002).
[9] G. P. Williams, Rev. Sci. Instr. 73, 1461 (2002).
[10] G. Ramian, Nucl. Instr. Meth. A 318, 225 (1992).
[11] A. Doria, G. P. Gallerano, E. Giovenale, G. Messina, and I. Spassovsky, submitted to Phys. Rev. Lett. (2004).
[12] J. Urata, M. Goldstein, M. F. Kimmitt, A. Naumov, C. Platt, and J. E. Walsh, Phys. Rev. Lett. 80, 516 (1998).
[13] C. Hernandez Garcia and C. A. Brau, Nucl. Instr. Meth. A 475, 559 (2001).
[14] P. M. van den Berg, J. Opt. Soc. Am. 63, 689 (1973).
[15] P. M. van den Berg, J. Opt. Soc. Am. 63, 1588 (1973).
[16] P. M. van den Berg and T. H. Tan, J. Opt. Soc. Am. 64, 325 (1974).
[17] L. Schaechter and A. Ron, Phys. Rev. A40, 876 (1989).
[18] K.-J. Kim and S.-B. Song, Nucl. Instr. Meth. A475, 159 (2001).
[19] C. A. Brau, Modern Problems in Classical Electrodynamics (Oxford University Press, New York, 2004), p. 342.
[20] C. A. Brau, Modern Problems in Classical Electrodynamics (Oxford University Press, New York, 2004), pp. 291-292.
[21] A. Bakhtyari, J. E. Walsh, and J. H. Brownell, Phys. Rev. E 65, 066503 (2002).

What is claimed is:

1. A free electron laser for generating a Smith-Purcell radiation, comprising:
a. a grating having a first end, an opposite, second end, and a grating surface defined therebetween the first end and the second end;
b. an electron emitter for generating a beam of electrons, wherein the beam of electrons is characterized with a beam current and an electron velocity; and
c. a guiding member positioned therebetween the electron emitter and the grating for directing the beam of electrons along a path extending over the grating surface of the grating with a focal point so that in operation a Smith-Purcell radiation and an evanescent wave are generated by interaction of the beam of electrons with the grating, wherein the Smith-Purcell radiation is characterized with a range of wavelengths, and the evanescent wave is characterized with a phase velocity and a group velocity, and the focal point is located between the first end and the second end of the grating and in the path over the grating surface of the grating,
wherein, in operation, the beam current of the beam of electrons is equal to or greater than a threshold current and the group velocity of the evanescent wave is substantially close to zero or negative so that the evanescent wave travels backward, and electrons in the beam of electrons are bunched by interaction with the evanescent wave to substantially enhance the Smith-Purcell radiation over the range of wavelengths.

2. The free electron laser of claim 1, wherein the Smith-Purcell radiation comprises a coherent radiation.

3. The free electron laser of claim 1, wherein the Smith-Purcell radiation is emitted along a direction having an angle, θ, relative to the path of the beam of electrons.

4. The free electron laser of claim 1, wherein the grating has a plurality of grooves with a period.

5. The free electron laser of claim 4, wherein the bunched electrons in the beam of electrons are spatially periodically distributed.

6. The free electron laser of claim 5, wherein the Smith-Purcell radiation is substantially enhanced at harmonics of the evanescent wave.

7. The free electron laser of claim 1, wherein the electron emitter comprises a plurality of microtips arranged in an array.

8. The free electron laser of claim 7, wherein the electron emitter is capable of controlling the beam current and the electron velocity of the beam of electrons.

9. The free electron laser of claim 1, wherein the electron emitter comprises a cone-emitter.

10. The free electron laser of claim 1, wherein the guiding member comprises a plurality of directing and focusing electrodes.

11. The free electron laser of claim 1, wherein the evanescent wave has a wavelength longer than the longest wavelength of the Smith-Purcell radiation.

12. The free electron laser of claim 11, wherein the phase velocity of the evanescent wave is synchronous with the electron velocity of the beam of electrons.

13. The free electron laser of claim 12, wherein the group velocity of the evanescent wave is associated with the beam current of the beam of electrons.

14. The free electron laser of claim 1, wherein the free electron laser operates on a mode at which the group velocity of the evanescent wave is substantially close to zero such that no optical cavity is required.

15. The free electron laser of claim 1, wherein the free electron laser operates on a backward wave oscillator mode of which the group velocity of the evanescent wave is negative.

16. The free electron laser of claim 15, wherein the evanescent wave is output from one of the first end and the second end of the grating.

17. A laser for generating a Smith-Purcell radiation, comprising:
a. a grating member having a modulated surface;
b. an emitter for generating a beam of charged particles; and
c. means for directing the beam of charged particles along a path extending over the modulated surface of the grating member so that a Smith-Purcell radiation and an evanescent wave are generated by interaction of the beam of charged particles with the grating member, wherein the Smith-Purcell radiation is characterized with a range of wavelengths, and the evanescent wave is characterized with a phase velocity and a group velocity,
wherein the grating member and the emitter are adapted such that in operation the group velocity of the evanescent wave is substantially close to zero or negative, and the charged particles in the beam of charged particles are bunched by interaction with the evanescent wave to substantially enhance the Smith-Purcell radiation over the range of wavelengths.

18. The laser of claim 17, further comprising means for focusing the beam of charged particles over the modulated surface of the grating member.

19. The laser of claim 17, wherein the Smith-Purcell radiation comprises a coherent radiation.

20. The laser of claim 17, wherein the Smith-Purcell radiation is emitted along a direction having an angle, θ, relative to the path of the beam of charged particles.

21. The laser of claim 17, wherein the grating member comprises a plurality of grooves with a period.

22. The laser of claim 21, wherein the bunched charged particles in the beam of charged particles are spatially periodically distributed.

23. The laser of claim 22, wherein the Smith-Purcell radiation is substantially enhanced at harmonics of the evanescent wave.

24. The laser of claim 17, wherein the emitter comprises an electron emitter array.

25. The laser of claim 24, wherein the beam of charged particles comprises a beam of electrons.

26. The laser of claim 17, where the beam of charged particles is characterized with a beam current and a particle velocity, and wherein the beam current has a threshold current.

27. The laser of claim 26, wherein the phase velocity of the evanescent wave is controllable to be synchronous with the particle velocity of the beam of charged particles.

28. The laser of claim 27, wherein the group velocity of the evanescent wave is associated with the beam current of the beam of charged particles.

29. A method for generating a Smith-Purcell radiation, comprising the steps of:
a. passing a beam of electrons along a path extending over a grating member to produce a Smith-Purcell radiation and an evanescent wave by interaction of the beam of the electrons with the grating member, wherein the Smith-Purcell radiation is characterized with a range of wavelengths, the evanescent wave is characterized with a phase velocity and a group velocity, and the grating member has a modulated surface; and
b. controlling the interaction of the beam of the electrons with the grating member such that the group velocity of the evanescent wave is substantially close to zero or negative to cause the evanescent wave backward-traveling over the grating member and allow the beam of electrons to be bunched by interaction with the evanescent wave to enhance the Smith-Purcell radiation over the range of wavelengths.

30. The method of claim 29, further comprising the step of focusing the beam of electrons over the modulated surface of the grating member.

31. The method of claim 29, wherein the Smith-Purcell radiation comprises a coherent radiation.

32. The method of claim 31, wherein the Smith-Purcell radiation is substantially enhanced at harmonics of the evanescent wave.

33. The method of claim 29, where the beam of electrons is characterized with a beam current and an electron velocity, and wherein the beam current has a threshold current.

34. The method of claim 33, wherein the phase velocity of the evanescent wave is synchronous with the particle velocity of the beam of electrons.

35. The method of claim 34, wherein the group velocity of the evanescent wave is associated with the beam current of the beam of electrons.

36. A laser for generating a Smith-Purcell radiation, comprising:
a. means for generating a beam of electrons passing along a path extending over a grating member to produce a Smith-Purcell radiation and an evanescent wave by interaction of the beam of the electrons with the grating member, wherein the Smith-Purcell radiation is characterized with a range of wavelengths, and the evanescent wave is characterized with a phase velocity and a group velocity; and
b. means for controlling the interaction of the beam of the electrons with the grating member such that the group velocity of the evanescent wave is substantially close to zero or negative to cause the evanescent wave backward-traveling over the grating member and allow the beam of electrons to be bunched by interaction with the evanescent wave to enhance the Smith-Purcell radiation over the range of wavelengths.
